(19) United States
(12) Patent Application Publication
(10) Pub. No.: US 2010/0042616 A1
(43) Pub. Date: Feb. 18, 2010

(54) SYSTEMS AND METHODS FOR SELECTING AND PRESENTING REPRESENTATIVE CONTENT OF A USER

(76) Inventor: Peter Rinearson, Vashon, WA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/540,115

(22) Filed: Aug. 12, 2009

Related U.S. Application Data
(60) Provisional application No. 61/088,309, filed on Aug. 12, 2008.

(51) Int. Cl. G06F 7/10; G06F 17/30

(52) U.S. Cl. 707/5; 707/E17.014

(57) ABSTRACT

Representative content of a user may be selected from the content submitted by the user and available on a website. The content may be rated and the selection of the representative content may be based upon the user ratings. The ratings may be submitted by other users and/or may be received or derived from other sources, such as an editorial board, website employees, hit-count, or the like. The representative content may include the highest-rated, lowest-rated, and/or average-rated content items submitted by the user. Indications of the representative content items may be displayed in connection with content submitted by the user. Displaying the indications of the representative content may motivate users to author and/or submit quality content to the website. The representative content displayed in connection with content submitted by the user may provide an easy-to-digest assessment of the user's corpus.

### CROSS-REFERENCE TO RELATED APPLICATIONS

This application claims the benefit of U.S. Provisional Application No. 61/088,309 filed Aug. 12, 2008, which is fully incorporated herein by reference.

### TECHNICAL FIELD

This disclosure relates generally to systems and methods for increasing the quality of user-submitted content and, in particular, to displaying indicators of representative content of a user in connection with content submitted by the user.

### SUMMARY OF THE INVENTION

A user may author a plurality of content items, which may be submitted to a website. The content items may be rated by other users of the website. One or more representative content items of the user may be selected from the plurality of submitted content items. The representative items may include a high-rated content item and a low-rated content item. The selection of the representative content items may be based upon ratings of the content items. An indication of the low-rated content item may be displayed in connection with content submitted by the user, such as content items submitted by the user, posts submitted by the user, commentary provided by the user, ratings provided by the user, and the like. In some embodiments, the high-rated content item and/or an average rated content item may also be displayed in connection with content submitted by the user.

The high-rated content item may be the content item, or be among the content items, having the best ratings. The low-rated content item may be the content item, or be among the content items, having the lowest ratings. The average rated content item may be the content item, or among the content items, having an average, weighted average, or mean rating. The selection of the representative content items may be predicated on a rating quality threshold. The rating quality threshold may relate to a rating count and/or a variance of the ratings. If an item has not received enough ratings (e.g., fails to satisfy a rating count threshold) and/or the ratings are not consistent (e.g., fails to satisfy a rating variance threshold), the item may not be available for selection as a representative content item.

The website may provide an interface configured to display content submitted by the user. The interface may be adapted to display the content, as well as the indicators of the representative content submitted by the user. The interface may include one or more inputs through which users may submit ratings of the content item. The ratings may be used to select the representative content items of the user. The interface may include a plurality of different rating inputs configured to receive ratings of various different aspect or rating categories of the content item.

The user may have a user profile, which may include identifying information about the user, such as a user name, an avatar, a profile photograph, metadata about their use of the site, and the like. The indications of the representative content items may be displayed on the user profile.

The indications of the representative content items may be links. Selection of a link may cause a representative content item to be displayed.

An aggregate rating of the content items submitted by the user may be calculated. The aggregate rating may be determined from ratings of content submitted by the user. The ratings may be submitted by other users of the website. Alternatively, or in addition, ratings may be provided from other sources, such as a rating service, an editorial board, website employees or administrators, and the like. Similarly, ratings may be derived from various metrics, such as a hit-count, inbound link metrics, and so on. The aggregate rating may be weighted, such that ratings submitted by certain users and/or from certain sources are given a greater weight than other ratings (e.g., ratings submitted by other users). The weight accorded to a particular rating may be based upon a user rating weight of the user, the seniority of the user, credibility of the rating source, or the like.

Various aspects or categories of a user-submitted content item may be rated. Overall aspect and/or category ratings of a content item may be calculated based upon the ratings. The aggregate rating of a content item may be derived from the various overall ratings of the item. The overall ratings may be accorded different respective weights in calculating the aggregate rating.

### BRIEF DESCRIPTION OF THE DRAWINGS

FIG. 1 is one embodiment of a user profile comprising a user's high-rated content item and a low-rated content item;

FIG. 2 is one embodiment of an interface including a user profile comprising a high-rated content item, an average-rated content item, and a low-rated content item display;

FIG. 3 is one embodiment of an interface configured to display a user-submitted content item, and to receive a user rating of the content item;

FIG. 4 is a flow diagram of a method for displaying indicators of representative content in connection with user-submitted content; and

FIG. 5 depicts one embodiment of a system for selecting and displaying representative content in connection with user-submitted content.

### DETAILED DESCRIPTION OF PREFERRED EMBODIMENTS

Websites and services (collectively websites) featuring user-submitted content have become very popular and are among the fastest growing websites on the Internet. Many of these websites rely on the quality of the content submitted by their users (i.e., the user “community” of the website or service) to attract and retain users. As such, these websites may wish to induce their users to author and/or submit high-quality content to the website.

As used herein, user-submitted content may be referred to as a “content item,” or “item” and may include, but is not limited to: an image, an illustration, a drawing, a pointer (e.g., a link, uniform resource indicator (URI), or the like), a map or location-centric content, video content, Adobe Flash® content, audio content (e.g., a podcast, music, or the like), text content, a game, downloadable content, metadata content, a blog post or entry, a collection and/or arrangement of content items (e.g., into a time-sequence, such as a story or other arrangement), or any other user-submitted content. In addition, a content item may include, but is not limited to: a text posting in a threaded or un-threaded discussion or forum, a content item (as defined above) posting in a threaded or un-threaded discussion, a user-submitted message (e.g., forum mail, email, etc.), or the like.

One way such websites encourage user-contributors to author and/or submit quality content is by providing for rating of content. In some embodiments, content may be rated and/or critiqued by other community users. Alternatively, or in addition, content ratings may be provided from other sources, such as an external rating source, a view count metric, or the like. Indications of the ratings may be displayed in connection with the user-submitted content. The submitter of the content may want to be sure that his/her content is highly rated, which may encourage the user to increase the quality of the content submitted to the website.

In addition, many content driven websites allow their users to create “user profiles.” A user profile may comprise a data set associated with a particular user-contributor of the website and may comprise a user name, contact information, a user photo and/or avatar, metadata about the user's participation on the site, or the like. The user profile may also comprise an overall rating of content submitted by the user. The overall rating may be related to and/or derived from other users' ratings of content contributed by the user. For example, a user who consistently authors and/or submits highly rated content may have a high user rating, a user who consistently authors low-rated content may have a low user rating, and so on. In some embodiments, a user may also be assigned a rating weight. The rating weight may be used to combine different ratings into an overall or aggregate rating of a content item. The rating weight of a user may be maintained and/or calibrated based upon the quality of the ratings submitted by the user (e.g., as compared to an expert rating of the content item). Systems and methods for calibrating a user rating weight are described in co-pending application Ser. No. ______ (attorney document No. 38938/11), filed on Aug. 12, 2009, and entitled “Systems and Methods for Calibrating User Ratings,” which is hereby incorporated by reference in its entirety.

The user rating and/or rating weight may be displayed in connection with the user's profile and may be indicative of the overall quality of the user's submitted content and/or the quality of the ratings provided by the user. The user profile, and the associated user rating and/or rating weight, may be displayed with and/or linked to posts and/or content submitted by the user. In some embodiments, the user profile may be displayed in-line with user-submitted content and/or posts. As such, other users in the community may be given easy access to the user-contributor's profile and its associated overall user rating.

Since users' rating information may be prominently displayed in conjunction with user-submitted content and/or posts, content submitted by highly rated users may be given greater weight and attention by other members of the user community than content submitted by other, perhaps lower-rated, users. This may create “peer-pressure-” type motivation to encourage users to author and/or submit high-quality content to the website to increase their gravitas on the website.

In addition to an overall user rating, a user profile may display a range or summary of content submitted by the user. In some embodiments, the display may comprise indicators of representative content submitted by the user. The representative content items may include a “best” user-submitted content item (i.e., highest rated) and a “worst” user-submitted content item (i.e., lowest rated). The high-rated and low-rated representative content items may provide an effective and powerful indication of the quality of the user-contributor's corpus. In some embodiments, the representative content item may include only the “worst” user-submitted content item. Alternatively, or in addition, an indication of an average-rated user content item may also be provided (e.g., a user-contributed content item that has a rating corresponding to the average or mean of the user's rating).

Displaying representative user-contributed content in connection with a user profile may not only provide a strong inducement for user-contributors to submit quality work, but also provide a quick assessment of a user-contributor's corpus and may serve as an easily digested critique of the user's work.

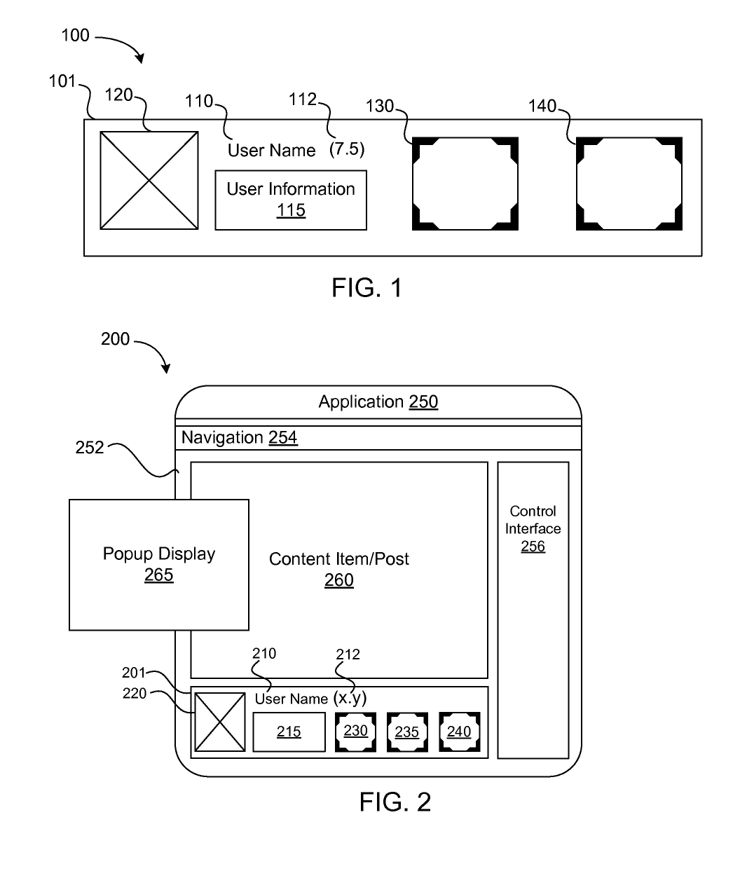

FIG. 1 depicts one embodiment 100 of a user profile 101 comprising indicators of representative content submitted by the user. In the FIG. 1 example, a high-rated indicator 130 and a low-rated indicator 140 are provided on a user profile 101. However, the indicators 130 and/or 140 could be displayed independently of the user profile 101.

The user profile 101 may include a user name 110, an overall user rating 112, user information 115, an avatar 120, and representative content indicators 130 and 140. The indicator 130 may correspond to a high-rated content item (e.g., a high-rated content item), and the indicator 140 may correspond to a low-rated content item (e.g., a low-rated content item). In some embodiments, only a single indicator may be displayed (e.g., only the high-rated indicator 130 and/or the low-rated content item indicator 140).

The user name 110 may be the registered user name of the user and may comprise a text string, image, or the like. The overall user rating 112 may be displayed in connection with the user profile 101. As discussed above, the user rating 112 may represent an average rating given to content items submitted by the user. The user name 110 may be associated with user information 115, which may comprise a user-provided description, motto, contact information (e.g., email address, instant messenger name, or the like), biographical information, and the like.

The avatar 120 may comprise an image, video, audio, or any other content and may serve as a depiction or descriptor of the user. The avatar 120 may comprise a realistic or stylized image of the user. Alternatively, the avatar 120 may be a whimsical image or other content used to identify or distinguish the user.

The user profile 101 may comprise a high-rated content item indicator 130 and a low-rated content item indicator 140. These indicators 130 and 140 may be displayed in connection with the user profile 101. The indicators 130 and 140 may provide a display or other depiction (e.g., thumbnail image, audio clip, etc.) of the best and worst rated content items submitted by the user associated with the user profile 101.

As used herein, a user-submitted content item may include, but is not limited to: an image, an illustration, a drawing, pointer (e.g., a link, URI, or the like), video content, interactive content (e.g., Adobe Flash® content), audio content (e.g., a podcast, music, or the like), text content, a game, downloadable content, metadata content, a blog post or entry, location-based content, time-based content, a collection and/or arrangement of content items, or any other user-submitted content.

Due to size constraints in user profile 101, the high- and low-rated content item indicators 130 and 140 may be scaled and displayed in a compressed format (e.g., as a thumbnail image). Where the content items 130, 140 are non-visual (e.g., text, audio, or the like), links and/or player components may be provided. Similarly, where the content item indicators 130, 140 cannot be adequately viewed in a small display area (e.g., a video, a collection of other content items, or the like), the indicators 130 and 140 may provide links to an appropriate viewer. The high- and/or low-rated content items may be of different types (e.g., the high-rated content item may be an image, and the low-rated content item may be an audio recording); accordingly, the indicators 130 and/or 140 may include different viewing components (e.g., a thumbnail image display and an audio player component). In other embodiments, the best and low-rated content item indicators 130 and 140 may be enlarged to allow for a higher-quality display. Alternatively, or in addition, the high-rated content item indicator 130 may display a rating of the high-rated content item (e.g., 9 out of a possible 10) and the low-rated content item indicator 140 may display a rating of the low-rated content item (e.g., 1 out of a possible 10). In some embodiments, these rating values may be displayed in place of the respective high-rated and low-rated content items, may be overlaid on a representation of the items, or the like.

A user accessing the user profile 101 may immediately be given a quick assessment of the user-contributor's corpus. In addition, the best and low-rated content item indicators 130, 140 may provide an easy-to-digest critique of the content submitted by the user. Moreover, since the best and low-rated content items 130, 140 are displayed in connection with the user profile 101; the user will be motivated to produce high quality content to avoid having a low-rated content item associated with his or her user profile 101 and/or to showcase his or her high-quality content.

FIG. 2 depicts one embodiment 200 of a user profile 201 comprising an indication 230 of a high-rated content item, an indication 235 of an average-rated content item, and an indication 240 of a low-rated content item. The indications 230, 235, and/or 240 may be displayed in conjunction with an application 250. The application 250 may comprise web browser software, such as Microsoft Internet Explorer®, Mozilla Firefox®, Opera®, or the like. The application 250 may be configured to display content formatted according to an HTML, Extensible Markup Language (XML), and/or another format (e.g., Flash®, Silverlight®, Portable Document Format (PDF), or the like). In an alternative embodiment, the application 250 may comprise media player software, such as Windows Media Player®, Winamp®, or the like. The application 250 may comprise a navigation component 252, which may be used to enter a uniform resource locator (URI) to access a website (e.g., a server communicatively coupled to a network, such as the Internet) and/or to navigate within a website and/or network. The URI may be formed according to RFC 1630, 1738, 2396, 2732, 3986, or another standard, and may comprise a domain name indicator (e.g., www.example.com), which may be used to access content located on a network.

The application 250 may comprise a display 252 wherein data, such as HTML or other renderable data, may be presented to a user. The display 252 may comprise a control interface 256, which may provide browsing and/or searching functionality to allow users of the application 250 to access content on the website. As such, the control interface 256 may comprise a search component (not shown) to allow a user to search for a content item and/or post on the website using one or more search terms, keywords, and/or tag. A search module of the website and/or external search service may compare the one or more search terms to, inter alia, content metadata to determine a match.

A content item or post 260 may be presented in the display 252. As discussed above, a user-submitted content item or post 260 may include, but is not limited to: an image, an illustration, a drawing, pointer (e.g., a link, URI, or the like), video content, Adobe Flash® content, audio content (e.g., a podcast, music, or the like), text content, a game, downloadable content, metadata content, a blog post or entry, a collection and/or arrangement of content items, or any other user-submitted content. In addition, a content item or post 260 may include, but is not limited to: a text posting in a threaded or un-threaded discussion or forum, a content item (as defined above) posting in a threaded or un-threaded discussion, a user-submitted message (e.g., forum mail, email, etc.), or the like.

The content item or post 260 may be submitted by a user. A user profile 201 of the user who submitted the content item or post 260 may be provided in the display 252. As described above, the user profile 201 may comprise the user name 210 of the user-contributor, an average or overall rating of content submitted by the user 212, user information 215, a user avatar 220, and representative user-submitted content item indications 230, 235, 240. The indication 230 may represent the high-rated (e.g., most highly rated) user-submitted content item, the indication 235 may represent an average-rated (e.g., rated at the user's overall average or mean rating) user-submitted content item, and the indication 240 may represent the low-rated (e.g., lowest rated) user-submitted content item. As depicted in FIG. 2, the indications 230, 235, and/or 240 may be compressed (e.g., displayed as a thumbnail) due to size constraints on the display 252. Similarly, where the content-item is non-visual (e.g., audio, text, or the like), links may be provided and/or a viewing component may be provided.

In some embodiments, the user profile 201 may be displayed in conjunction with the content item or post 260 submitted by a particular user. As such, the high-rated content item indication 230, the average-rated content item indication 235, and the low-rated content item indication 240 may be made available to other users in the community through the user profile 201. The user profile 201 may be displayed in conjunction with content and posts submitted by the user. Since the best, worst, and average indications 230, 235, and 240 are visible to other users, the submitter may be motivated to submit content items of the highest quality to avoid having low-quality content associated with his/her user profile 201 and to showcase the user's high-quality content submissions. Although in the FIG. 2 example, the indications 230, 235, and 240 are shown within a user profile 201, the disclosure is not limited in this regard. The indications 230, 235, and/or 240 could be displayed independently of the user profile 201 and/or in connection with other portions of the application 250 under the teachings of this disclosure.

Users of the website or service accessing a content item or post 260 submitted by a particular user (or simply accessing the user profile 201) may be provided with a quick assessment of the user-contributor's corpus. The overall quality of content items or posts submitted by the user may be bounded by the two (or three in FIG. 2) extremes of the high-rated content item indication 230 and the low-rated content item indication 240. Similarly, the high-rated content item indication 230, the average-rated content item indication 235, and the low-rated content item indication 240 may act as an easily digested critique of the user contributor's work.

The indications 230, 235, 240 may be adapted to display the high-, average-, and/or low-rated content items 230, 235, and/or 240. Accordingly, the indications 230, 235, and/or 240 may comprise display areas adapted to display a content item (e.g., one or more of the indications 230, 235, and/or 240 may comprise an image display, a video player component, an audio player component, or the like). The interface 200 and/or the indications 230, 235, and/or 240 may be mutable; for example, the interface 200 may allow a user to resize one or more of the indications 230, 235, and/or 240 to provide a more detailed display of the high-, average-, and/or low-rated items.

In some cases, it may not be desirable to display a particular content item in the indications 230, 235, and/or 240 (e.g., if the content item is text, an interactive application, or is otherwise unsuitable for display in an indication 230, 235, and/or 240). Accordingly, in some embodiments, the indications 230, 235, and/or 240 may provide a rating value in place of a display or other indicator of the high-, average-, and/or low-rated content items. Similarly, the indications 230, 235, and/or 240 may further comprise respective links to allow a user to access and/or navigate to a “full-size” view of the high-rated, low-rated, and/or average-rated content items. Accordingly, selection of a link in one or more of the indications 230, 235, and/or 240 may cause the application 250 to navigate to another display interface (not shown) configured to display the respective content item. In some embodiments, selection of a link in an indication 230, 235, and/or 240 may cause a popup display 265 to be presented; the popup display 265 may be configured to display one or more of the high-rated, average-rated, and/or low-rated items. Alternatively, or in addition, selection of a link in one or more of the indications 230, 235, and/or 240 may cause the high-, average-, and/or low-rated item to be displayed in the interface 200 (e.g., in place of the content item or post 260), to be displayed in another area in the interface 200 (e.g., on another panel or other display area in the interface 200 (not shown)), to be displayed on another panel of the interface 200 (not shown), or the like.

In addition, links in the indications 230, 235, and/or 240 may direct the application 250 to an interface (not shown) that provides a list or other summary of the content submitted by the user. The items in the list or summary may be ordered according to their respective ratings. For example, a user may select a link in the high-rated item indication 230 and be linked to the most highly rated content items submitted by the user. Selection of a link in the low-rated indication 240 may cause the application 250 to navigate to a listing of the low-rated items submitted by the user, and so on. In some embodiments, the control interface 256 may comprise one or more controls configured to allow the user to navigate to a “next-best” rated content item submitted by the user (e.g., the content item having the next highest user rating) and/or to a “next-worst” rated content item submitted by the user (e.g., the content item having the next worst user rating), to thereby allow a user to browse the corpus of the user in order of their relative rating.

Although FIG. 2 shows the indications 230, 235, and/or 240 displayed within a user profile 201, the disclosure is not limited in this regard. The indications 230, 235, and/or 240 could be displayed independently of user profile information and/or in connection with only a subset of the information shown in the user profile 201. For example, the indications 230, 235, and/or 240, could be displayed with only an indication of the identity of the submitter of the representative content items.

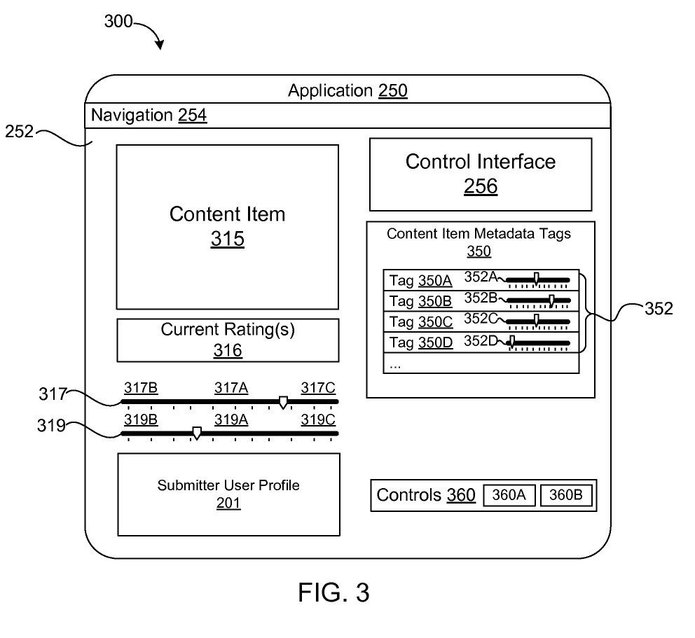

FIG. 3 shows one embodiment of an interface configured to display user-submitted content to other users of a website. The interface 300 may be presented in an application 250, which may include a navigation component 254, a control interface 256, and a display 252. A navigation interface 254 may be provided to allow a user to navigate to various locations (e.g., URLs) within a network. The control interface 256 may be configured to allow for navigation within a particular website; accordingly, the control interface 256 may comprise a search field (not shown), website navigation components (not shown), or the like.

The content presentation interface 300 may include a display 252 adapted to render HTML data. The display 252 may include components adapted to display a user-submitted content item 315. As discussed above, the content item 315 may comprise one or more of many different types of content. The interface 300 may be adapted to include an appropriate viewer and/or player for the content item 315 (e.g., video player, image viewer, and so on).

The interface 300 may include a user profile 201 of the author and/or submitter of the content item 315. The user profile 201 may include a user name (not shown), a user rating (not shown), an avatar (not shown), and/or indicators of representative content submitted by the user (e.g., high-, low-, and/or average-rated content submitted by the user).

The interface 300 may include one or more rating inputs 317, 319, and 352 to allow users to rate various aspects of the user-submitted content item 315 and/or metadata associated therewith. The metadata may include any data used to describe the content item 315, such as a title (not shown), description (not shown), background (not shown), location (not shown), time frame (not shown), tags 350, or the like.

The rating inputs 317 and 319 may allow a user to submit a rating of one or more aspects or categories of the content item 315 (e.g., a subject appeal of the item 315, technical merit of the item 315, and the like). The rating inputs 317 and 319 may each comprise a respective title 317A and 319A, which may indicate the category or aspect (e.g., “subject appeal”) to be rated. The rating inputs 317 and 319 may comprise an input through which a rating may be entered (e.g., a low-range indicator 317A, 319B (e.g., “unappealing”) and a respective high-range indicator 317C, 319C (e.g., “appealing”)).

The interface 300 may comprise one or more metadata tags 350 (e.g., tags 350A-350D) and metadata tag rating inputs 352 (e.g., 352A-352D). The metadata tags 350A-350D may be used to describe and/or categorize the primary content item 315. The tags 350 may be rated using rating inputs 352. Various aspects of the tags may be rated, such as tag relevance, descriptiveness, or the like.

Interface 300 may comprise controls 360, which may include a save or upload input 360A and a cancel input 360B. The save input 360A may submit the entries provided in the one or more rating inputs 317, 319, and 352 to the website. Selection of the cancel input 360B may clear the rating inputs 317, 319, and 352.

Selection of the save or upload input 360A may cause the user-submitted ratings entered via the interface 300 to be received by the website. The ratings may be stored on a computer-readable storage medium. The ratings of the content item 315 may be used to generate an overall rating of the various aspects or categories of the content item 315 (e.g., subject appeal, technical merit, and so on). In addition, an aggregate rating of the content item 315 may be generated. The aggregate rating may be derived from a general “overall” rating input provided on the interface 300 and/or may be derived by combining one or more rating categories (e.g., combining “subject appeal” and “technical merit” ratings). In some embodiments, the aggregate rating may be based on weighted rating categories (e.g., the “technical merit” ratings of the content item 315 may play a larger role in the aggregate rating of the content item 315 than the “subject appeal” ratings).

In some embodiments, the ratings used to derive the overall aspect ratings and/or the aggregate rating of the content item 315 may be weighted based on the source of the ratings. For example, ratings submitted by highly-rated users may be given greater weight than users that have a lower user rating. This may give well-respected users greater influence over the ratings of various items 315 on the site. In some embodiments, user-submitted ratings may be weighted according to a user rating weight.

The current ratings of the content item 315 may be displayed in connection with the content item 315 in a current rating(s) display 316. The current rating(s) display 316 may include the current average (or weighted) rating of the various aspects of the content item 315 (e.g., the aspects of the content item rated by the inputs 317 and 319). In addition, the current rating(s) display 316 may include the aggregate rating of the content item 315, which, as discussed above, may be generated from ratings of the various aspects of the content item 315 (e.g., may be an average, a weighted average, or some other derivation of the aspect ratings).

The ratings of the content item 315 displayed in the current rating(s) display 316 may be used to select the item as representative of the user-contributor's corpus. For example, if the aggregate rating of the content item 315 is low relative to the other items submitted by the user, the content item 315 may be selected as the low-rated content item of the user. Therefore, an indicator of content item 315 may be displayed in connection with the user profile 201 (e.g., in a low-rated content item indicator, such as the indicator 240 discussed above). If the aggregate rating of the content item 315 is the highly rated with respect to the other items submitted by the user, the content item 315 may be selected as the high-rated content item of the user, and so on. In some embodiments, the selection of the high-, low-, and/or average-rated items for the user may be based upon other ratings. For example, the high-, low-, and/or average-rated items may be selected from a particular rating aspect of the item (e.g., “technical merit”) as opposed to the “overall” rating of the item. This may allow technically superior work of the user to be highlighted, even if the subject matter of the work is not appealing to very many users. Similarly, other metrics may be used in the selection of the representative items. For example, the number of accesses and/or links to the content item 315 may be used in selecting the “best” item of the user; in this case, the popularity of the item may be used (along with one or more ratings) to select the representative items.

Although user-submitted ratings are discussed in FIG. 3, the disclosure is not limited in this regard. Ratings of user-submitted content could be received via any number of different sources under the teachings of this disclosure. For instance, ratings may be received from sources other than website users, such as external rating services, an editorial board, website employees, or the like. Similarly, ratings may be derived from various metrics, such as a hit-count of the content item (e.g., a metric of the number of times the content item has been viewed), an inbound link count of the item, of the like. Therefore, the disclosure should not be read as limited to any particular set of ratings and/or to ratings received from a particular source.

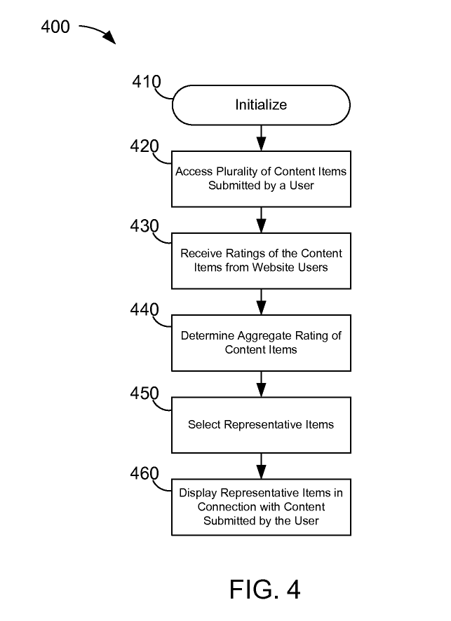

FIG. 4 is a flow diagram of a method for displaying representative content in connection with user-submitted content. The method 400 may comprise one or more machine executable instructions stored on a computer-readable storage medium. The instructions may be configured to cause a machine, such as a computing device, to perform the method 400. In some embodiments, the instructions may be embodied as one or more distinct software modules on the storage medium. One or more of the instructions and/or steps of method 400 may interact with one or more hardware components, such as computer-readable storage media, communications interfaces, or the like. Accordingly, one or more of the steps of method 400 may be tied to particular machine components.

At step 410, the method 400 may be initialized, which may comprise accessing and/or initializing resources required by the method 400 (e.g., memory, computer-readable storage media, communications interfaces, and the like).

At step 420, the method 400 may access and/or receive a plurality of content items submitted by a user. The content items may be received over time and/or may be transmitted in a bulk upload operation. The items may be stored on a computer-readable storage medium and made available for display to one or more users of a website (e.g., in an interface, such as the interface 300 of FIG. 3).

At step 430, ratings of the content items may be received. The ratings may be related to one or more aspects or categories of the content items. The ratings may be submitted by users having respective user profiles, which, as discussed above, may include an overall user rating of the rating users. Alternatively, or in addition, the ratings may be received and/or derived from another source, such as a rating service, an editorial board, an expert, a website employee or administrator, a hit count, an inbound link metric, or the like.

At step 440, the ratings may be used to generate respective overall and/or aggregate ratings of the content items. In some embodiments, step 440 may comprise determining an overall rating for each rating aspect and/or category of the content items (e.g., an overall “technical merit” rating, an overall “subject appeal” rating, and so on). The overall ratings may be an average of the ratings in each rating aspect or category. Alternatively, the overall ratings may be a weighted average, wherein ratings of certain users and/or from certain sources are given a greater weight than ratings from other sources (e.g., from other users based upon the user rating of the users, seniority of the users on the website, reliability of the source, or the like).

The overall aspect or category ratings may be used to generate an aggregate rating of the content items. In some embodiments, the aggregate rating may be an average of the overall ratings of the content items (e.g., an average of the “technical merit” overall rating, the “subject appeal” overall rating, and so on). Alternatively, the aggregate rating may be derived from weighted overall rating categories (e.g., the “technical merit” overall rating may be given a greater weight than the “subject appeal” overall rating). In some embodiments, one or more of the content items may have an “overall” or “aggregate” rating input, which may be used to determine the aggregate rating of the content items.

As could be appreciated by one of skill in the art, any number of different techniques could be used to determine an aggregate and/or overall rating of the content items at step 440. Accordingly, this disclosure should not be read as limited to any particular rating technique.

At step 450, one or more representative items may be selected. The representative content items may be selected from the content items submitted by the user (accessed at step 420). The representative items may include high-, low-, and/or average-rated content items of the user. In some embodiments, the representative items may include various sets of representative items (e.g., high-rated “subject appeal” items, low-rated “technical merit” items, and so on).

The selection of step 450 may be based on the aggregate ratings of the user-submitted content items. Alternatively, or in addition, the selection may be based upon one or more rating aspects or categories of the content items. For example, a set of representative content items may be selected, such as a set of high-, low-, and average-rated “subject appeal” content items, a set of high-, low-, and average-rated “technical merit” content items, and so on. The selection of these items may be based on the overall aspect or category ratings discussed above (e.g., as opposed to the aggregate ratings of the content items).

The selection of step 450 may include determining a rating quality for each of the content items. The rating quality may be compared to a threshold and, if the threshold is not satisfied, the item(s) may be removed from consideration for the selection of step 450. The rating quality of a content item may be based upon various factors, including the number of ratings of the content item that have been received, the statistical quality of the ratings, and the like. For example, content items for which only a few ratings have been received (e.g., only a few users have rated the item) and/or whose ratings are not consistent (e.g., exhibit a high degree of variance) may be excluded from the selection. Accordingly, the rating quality threshold may include a rating count threshold and/or a rating variance threshold. If the ratings of a particular content item do not satisfy the rating quality threshold, the item may be removed from consideration as a representative content item of the user (e.g., not considered for selection as a high-, low-, and/or average-rated content item).

At step 460, the representative content items (or links thereto) may be stored in a computer-readable storage medium and made available for display in connection with content submitted by the user. In some embodiments, indicators of the representative content item may be displayed in a user profile of the user (e.g., the user profile 201 of FIGS. 2 and 3). The user profile may be displayed in connection with content submitted by the user (e.g., content items, posts, etc.). In some embodiments, all the content submitted by the user may be displayed in connection with the representative content indications; the content may include, but is not limited to: content items submitted by the user, messages posted by the user, commentary provided by the user, metadata submitted by the user, a user profile, ratings submitted by the user, and the like.

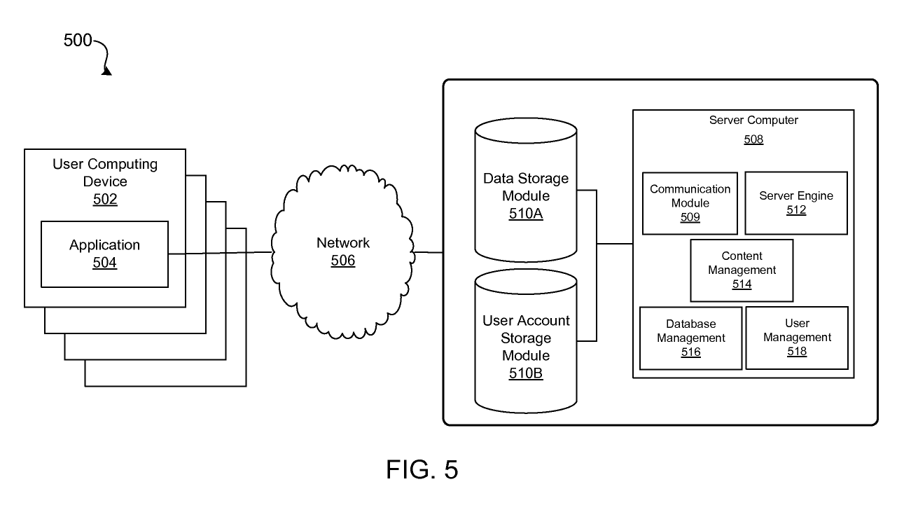

Aspects of the teachings of this disclosure may be practiced in a variety of other computing environments. FIG. 5 depicts one embodiment of a system 500 for providing a user profile comprising indicators of a high-rated content item, a low-rated content item and/or an average-rated content item. FIG. 5 shows a distributed network environment comprising one or more user computing devices 502 communicatively coupled to a server computer 508. The one or more user computing devices 502 may comprise an application 504 that may be used to access and/or exchange data with other computing devices on the network 506, such as the server computer 508. The application 504 may comprise a web browser, such as Microsoft Internet Explorer®, Mozilla Firefox®, Opera®, or the like. Alternatively, or in addition, the application 504 may comprise a media player and/or content presentation application, such as Adobe Creative Suite®, Microsoft Windows Media Player®, Winamp®, or the like. The user computing device 502 and/or the application 504 may comprise a network interface component (not shown) to allow the application 504 to communicate with and/or access content made available by the server computer 508 via the network 506. For example, Adobe Creative Suite® may provide access to a stock photo repository to allow users to purchase content for integration into an Adobe® project; a media player, such as Microsoft Windows Media Player®, may provide access to an online, streaming music to allow a user to purchase audio content therefrom; and a web browser may provide access to web accessible content on the network 506.

The application 504 may allow a user to access websites or other content accessible via a Transmission Control Protocol (TCP) Internet Protocol (IP) network (i.e., a TCP/IP network). One such network is the World Wide Web or Internet. One skilled in the art, however, would recognize that the teachings of this disclosure could be practiced using any networking protocol and/or infrastructure. As such, this disclosure should not be read as limited to a TCP/IP network, the Internet, or any other particular networking protocol and/or infrastructure.

The user computing devices 502 may comprise other program modules, such as an operating system, one or more application programs (e.g., word processing or spreadsheet applications), and the like. The user computing devices 502 may be general-purpose and/or specific-purpose devices comprising a processor, memory, computer-readable storage media, input-output devices, communications interfaces, and the like. The computing devices 502 may be adapted to run various types of applications, or they may be single-purpose devices optimized or limited to a particular function or class of functions. Alternatively, the user computing devices 502 may comprise a portable computing device, such as a cellular telephone, personal digital assistant (PDA), smart phone, portable media player (e.g., Apple iPod®), multimedia jukebox device, or the like. As such, this disclosure should not be read as limited to any particular user computing device implementation and/or device interface. Accordingly, although several embodiments herein are described in conjunction with a web browser application, the use of a web browser application and a web browser interface are only used as a familiar example. As such, this disclosure should not be read as limited to any particular application implementation and/or interface.

The network 506 may comprise routing, addressing, and storage services to allow computing devices, such as the user computing devices 502 and the server computer 508 to transmit and receive data, such as web pages, text content, audio content, video content, graphic content, and/or multimedia content therebetween. The network 506 may comprise a private network and/or a virtual private network (VPN). The network 506 may comprise a client-server architecture, in which a computer, such as the server computer 508, is dedicated to serving the one or more user computing devices 502, or it may have other architectures such as a peer-to-peer, in which the one or more user computing devices 502 serve simultaneously as servers and clients. In addition, although FIG. 5 depicts a single server computer 508, one skilled in the art would recognize that multiple server computers 508 could be deployed under the teachings of this disclosure (e.g., in a clustering and/or load sharing configuration). As such, this disclosure should not be read as limited to a single server computer 508.

The server computer 508 may be communicatively coupled to network 506 by a communication module 509. The communication module 509 may comprise one or more wired and/or wireless network interfaces capable of communicating using a networking and/or communication protocol supported by the network 506 and/or the user computing devices 502.

The server computer 508 may comprise and/or be communicatively coupled to a data storage module 510A. Data storage module 510A may comprise one or more databases, XML data stores, file systems, X.509 directories, Lightweight Directory Access Protocol (LDAP) directories, and/or any other data storage and/or retrieval systems known in the art. Accordingly, the data storage module 510A may include disc storage devices (e.g., hard discs), optical storage devices, or the like. The data storage module 510A may store web pages and associated content (e.g., user-submitted content) to be transmitted to one or more of user computing devices 502 over network 506.

The server computer 508 may comprise a server engine 512, a content page management component 514, and a data storage management module 516. The server engine 512 may perform processing and operating system level tasks including, but not limited to: managing memory access and/or persistent storage systems of the server computer 508, managing connections to the user computing device(s) 502 over the network 506, and the like. The server engine 512 may manage connections to/from the user computing devices 502 using a communication module (not shown).

The content management module 514 may create, display, and/or otherwise provide content to user computing device(s) 502 over network 506. In addition, and as will be discussed below, the content management module 514 may manage user profile information and user-submitted content displayed to or received from user computing devices 502. Data storage management module 516 may be configured to interface with the data storage module 510A to store, retrieve, and otherwise manage data in the data storage module 510A.

In some embodiments, the server engine 512 may be configured to provide data to the user computing devices 502 according to the HTTP and/or secure HTTP (HTTPS) standards. As such, the server computer 508 may provide web page content to the user computing devices 502. Although the server computer 508 is described as providing data according to the HTTP and/or HTTPS standards, one skilled in the art would recognize that any data transfer protocol and/or standard could be used under the teachings of this disclosure. As such, this disclosure should not be read as limited to any particular data transfer and/or data presentation standard and/or protocol.

The user computing devices 502 may access content stored on the data storage module 510A and made available by a content management module 514 via a URI addressing the server computer 508. The URI may comprise a domain name (e.g., www.example.com), which may be resolved by a domain name server (DNS) (not shown) in the network 506 into an Internet Protocol (IP) address. This IP address may allow the user computing devices 502 to address and/or route content requests through the network 506 to the server computer 508. The URI may further comprise a resource identifier to identify a particular content item on the server computer 508 (e.g., content.html).

Responsive to receiving a URI request, the server engine 512 may be configured to provide the content to the user computing device 502 (e.g., web page) identified in the URI. The content management module 514 and a data storage management module 516 may be configured to obtain and/or format the requested content to be transmitted to the user computing device 502 by the server engine 512.

Similarly, the server engine 512 may be configured to receive content submitted by a user via the one or more user computing devices 502. The user-submitted content may comprise a content item such as an image, a video clip, audio content, or any other content item. The user-submitted content may be made available to other users via the one or more user computing devices 502 via the server computer 508. User-submitted content may further include metadata, commentary, and the like. For example, users may submit ratings of content available on the server computer 508. In addition, ratings may be received and/or derived from other sources, such as a rating service, an editorial board, website employees or administrators, website metrics, and the like. The ratings may be received by the server computer 508 and may be used to generate a rating of the author and/or to select representative content items of the user-contributor (e.g., select high-, low-, and/or average-rated items submitted by the user) as described above.

The server computer 508 may comprise a user management module 518. The user management module 518 may access a user account data storage module 510B, which may comprise one or more user accounts relating to one or more users authorized to access and/or submit content to the server computer 508. The user account data storage module 510B may comprise user profile information. As discussed above, a user profile may comprise a user password, content accessed by the user, content submitted by the user, ratings of the content submitted by the user, an average of the ratings received by the user, and the like.

The server engine 512 may be configured to display user-submitted content to users accessing the server computer 508 via the network 506. The server engine 512 may be configured to display the representative items of the user in conjunction with the user-submitted content. The representative items may be displayed in a user profile stored in the user account data storage module 510B. The items and/or user profile may be displayed in connection with content items and/or posts submitted by a particular user. As discussed above, the representative items may be displayed in a user profile, which may include indicators of a high-rated user-submitted content item, a low-rated user-submitted content item, and/or an average-rated user-submitted content item. As such, the user profile stored in the user account data storage module 510B may comprise and/or be linked to content submitted by the user stored in the user account data storage module 510B and/or the data storage module 510A.

The server computer 508, the data storage module 510A, and the user account data storage module 510B may comprise security measures to inhibit malicious attacks thereon, and to preserve integrity of the messages and data stored therein. Such measures may include, but are not limited to: firewall systems, secure socket layer (SSL) communication, user authentication, public key infrastructure (PKI) authentication, password protection schemes, data encryption, and the like.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, module, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention.

We claim:

1. A computer-readable storage medium comprising instructions to cause a computing device to perform a method, comprising:
accessing a plurality of content items submitted by a user;
receiving a plurality of ratings of the plurality of content items submitted by the user;
selecting one or more representative content items from the plurality of content items submitted by the user, the representative content items including a low-rated representative content item;
displaying indications of the representative content items in connection with content submitted by the user.

2. The computer-readable storage medium of claim 1, wherein the representative content items include a high-rated content item, and wherein the high-rated and the low-rated content items are displayed in connection with content submitted by the user.

3. The computer-readable medium of claim 2, wherein the high-rated representative content item is the highest-rated content item submitted by the user, and wherein the low-rated representative content item is the lowest-rated content item submitted by the user.

4. The computer-readable storage medium of claim 1, further comprising providing an interface configured to display a content item submitted by the user, wherein the interface comprises indications of the representative content items.

5. The computer-readable storage medium of claim 4, wherein the interface comprises one or more rating inputs configured to receive one or more ratings of the content item displayed in the interface.

6. The computer-readable storage medium of claim 5, wherein the interface comprises a plurality of rating inputs, and wherein each rating input is configured to receive a rating of a different aspect of the content item displayed in the interface.

7. The computer-readable storage medium of claim 4, wherein the interface includes a user profile of the user, and wherein the indications of the representative content items are displayed on the user profile.

8. The computer-readable storage medium of claim 1, wherein the representative content items include an average-rated content item, and wherein the low-rated and the average-rated content items are displayed in connection with content submitted by the user.

9. The computer-readable storage medium of claim 1, wherein an indication of a particular one of the representative content items comprises a link, wherein selection of the link causes the particular representative content item to be displayed.

10. The computer-readable storage medium of claim 1, wherein an indication of a particular one of the representative content items comprises a display configured to display the representative content item.

11. The computer-readable storage medium of claim 10, wherein the display comprises a thumbnail image representation of the representative content item.

12. The computer-readable storage medium of claim 1, the method further comprising calculating an aggregate rating of each of the plurality of content items submitted by the user, wherein the aggregate rating of a particular content item is derived from a plurality of ratings of the particular content item, and wherein the selection of the representative content items is based on the aggregate ratings.

13. The computer-readable storage medium of claim 1, the method further comprising displaying an indication of the author of the representative content items.

14. A system for selecting and displaying representative content submitted by a user, comprising:
a computing device comprising a processor;
a content management module operable on the processor and comprising a plurality of items submitted by the user; and
a user management module operable on the processor and communicatively coupled to the content management module, the user management module configured to select one or more representative content items from the plurality of content items submitted by the user, the representative content items including a low-rated representative content item,
wherein the content management module is configured to provide an interface to display content submitted by the user, and wherein the interface includes indications of the representative content items.

15. The system of claim 1, wherein the representative content items include a high-rated content item, and wherein the high-rated and the low-rated content items are displayed in connection with content submitted by the user.

16. The system of claim 14, wherein the content management module is configured to receive a new content item submitted by the user, and wherein an interface configured to display the new content item includes indications of the representative content items.

17. The system of claim 14, wherein the interface comprises one or more rating inputs configured to receive one or more ratings of the content item displayed in the interface.

18. The system of claim 17, wherein the interface comprises a plurality of rating inputs, and wherein each rating input is configured to receive a rating of a different aspect of the content item displayed in the interface.

19. The system of claim 14, wherein the interface includes a display of a user profile of the user, and wherein the indications of the representative content items are displayed on the user profile.

20. The system of claim 14, wherein the representative content items include the highest-rated content item submitted by the user and a lowest-rated content item submitted by the user.

21. The system of claim 14, wherein the representative content items include an average-rated content item, and wherein the low-rated and the average-rated content items are displayed in connection with content submitted by the user.

22. The system of claim 14, wherein an indication of a particular one of the representative content items comprises a link, and wherein selection of the link causes the particular representative content item to be displayed.

23. The system of claim 14, wherein an indication of a particular one of the representative content items comprises a display configured to display the representative content item.

24. The system of claim 22, wherein the display comprises a thumbnail image representation of the representative content item.

25. The system of claim 14, wherein the content management module is configured to calculate an aggregate rating of each of the plurality of content items submitted by the user, wherein the aggregate rating of a particular content item is derived from a plurality of ratings of the particular content item, and wherein the selection of the representative content items is based on the aggregate ratings.

26. The system of claim 25, wherein the plurality of ratings of the particular content item include ratings submitted by users having respective user rating weights, and
wherein the user-submitted ratings used to calculate the aggregate ratings of the plurality of content items submitted by the user are weighted by the respective user rating weights.

27. The system of claim 25, the method further comprising calculating overall ratings for two or more rating categories of each of the plurality of content items;
wherein the aggregate ratings of the plurality of content items submitted by the user are calculated using the two or more overall ratings of each of the plurality of content items.

28. The system of claim 27, wherein the aggregate ratings of the plurality of content items submitted by the user are calculated using weighted overall ratings of each of the plurality of content items.

29. The system of claim 14, wherein the content management module is configured to calculate a rating quality of each of the plurality of content items submitted by the user, and
wherein a particular one of the plurality of content items submitted by the user is available for selection as a representative content item when the rating quality of the particular content item satisfies a rating quality threshold.

30. The system of claim 29, wherein the rating quality threshold is one of a rating count threshold and a rating variance threshold.

31. The system of claim 14, wherein interface includes an indication of the author of the representative content items.

32. A computer-implemented method for selecting and displaying representative user-submitted content, the method comprising:
accessing on a computer-readable storage medium, a plurality of content items submitted by a user, each of the plurality of content items having a respective rating;
selecting two or more representative content items from the plurality of content items submitted by the user, the representative content items including a high-rated representative content item and a low-rated content item;
providing an interface to display a content item submitted by the user, wherein the interface includes graphical indications of the representative content items and identifies the author of the representative content items.
